(19) United States
(12) Patent Application Publication
(10) Pub. No.: US 2024/0119394 A1
(43) Pub. Date: Apr. 11, 2024

(54) APPLICATION MODERNIZATION ASSESSMENT SYSTEM

(71) Applicant: Insight Direct USA, Inc., Chandler, AZ (US)

(72) Inventors: Mark Candelora, Reading, MA (US); Sara Smiles, McMurray, PA (US); Katie Ryan, Boston, MA (US); Ish Haque, Charlotte, NC (US); Michael Griffin, Wayland, MA (US)

(21) Appl. No.: 18/376,279

(22) Filed: Oct. 3, 2023

Related U.S. Application Data
(60) Provisional application No. 63/414,126, filed on Oct. 7, 2022.

(51) Int. Cl. G06Q 10/0637; G06F 8/70; G06Q 10/0635

(52) U.S. Cl. CPC G06Q 10/06375; G06F 8/70; G06Q 10/0635

(57) ABSTRACT

A computing device and method for preparing application data based on a migration recommendation includes collecting survey responses to categorized questions and assigning a score to each of the survey response. The scored survey responses are normalized and rationalization parameters are determined based on the normalized scores. Application data are prepared for migration based on a recommended disposition determined from the rationalization parameters.

### CROSS-REFERENCE TO RELATED APPLICATION

This application is a nonprovisional application claiming the benefit of U.S. provisional application Ser. No. 63/414,126, filed on Oct. 7, 2022, entitled “APPLICATION MODERNIZATION ASSESSMENT SYSTEM” by Mark Candelora, Sara Smiles, Katie Ryan, Ish Hague, and Michael Griffin.

### BACKGROUND

The present disclosure is directed, in general, to information technology management and, more specifically, to preparation of application data based on an application migration and/or modernization recommendation.

Application rationalization and modernization is a time-intensive process whereby specialists obtain, compile, and analyze information about an application portfolio and an organization's preferences to provide application migration and/or modernization recommendations to the organization. An organization's portfolio may contain a large number of applications that requires personnel and/or computing resources to analyze. Consistency is desirable among application migration and/or modernization recommendations, which can be difficult given the large number of applications within an organization's portfolio and the number of specialists required to analyze the application and organizational information.

### SUMMARY

A method in accordance with an example embodiment of this disclosure includes collecting survey responses to a plurality of closed-form questions and assigning a score to each of the survey responses to define a plurality of scores. Each of the questions is configured to elicit a survey response from one of a plurality of categories. The method further includes determining a normalized score associated with each of the plurality of scores to define a plurality of normalized scores. Each of the plurality of normalized scores range from a minimum normalized score to a maximum normalized score. The method further includes determining a plurality of rationalization parameters. Each of the rationalization parameters is based on a different subset of normalized scores associated with one of the plurality of categories. The method further includes determining a migration recommendation based on the rationalization parameters and preparing application data associated with the application based on the migration recommendation.

### BRIEF DESCRIPTION OF THE DRAWINGS

FIG. 1 is a block diagram of an example application modernization assessment system that includes a survey module, a calculation module, a recommendation module, and an application data preparation module.

FIG. 2 is a block diagram of an example survey module that includes a set of categorized questions.

FIG. 3 is a block diagram of an example calculation module that determines at least one rationalization parameter.

FIG. 4 is a block diagram of an example recommendation module that outputs a migration disposition based on one or more rationalization parameters.

FIG. 5 is a block diagram of an example application data preparation module that provides an application package based on the recommended disposition.

FIG. 6 is a flow chart that describes steps of an example method of assessing an application and automatically preparing application data based on the application assessment.

### DETAILED DESCRIPTION

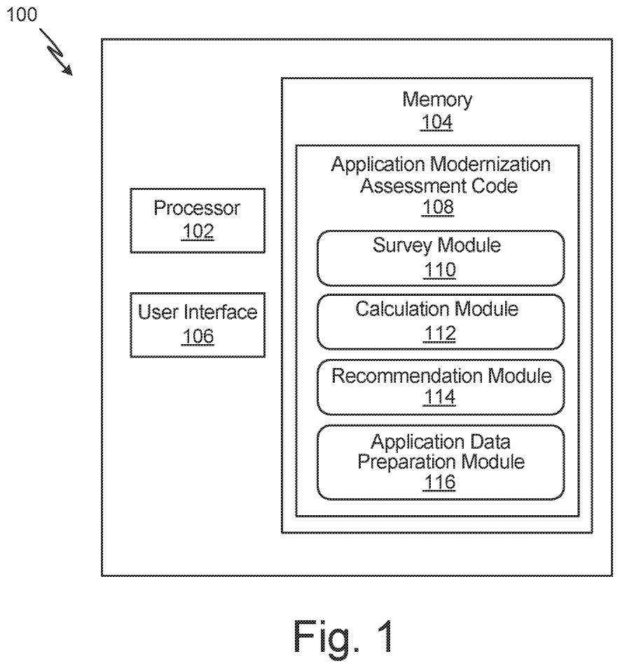

FIG. 1 is a block diagram of application modernization assessment system 100, which is a computing device configured to implement one or more data models used to perform methods described herein, and also automatic application data preparation for modernization and/or migration of applications based on a migration and/or modernization recommendation. In the depicted example, application modernization assessment system 100 includes processor 102, memory 104, and user interface 106. Application modernization assessment code 108 can be stored by memory 104 and includes survey module 110, calculation module 112, recommendation module 114, and application data preparation module 116.

Processor 102 can execute application modernization assessment code 108 and other software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium or computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that does not maintain stored contents when power to the memory 104 is turned off. Examples of volatile memories can include random access memories (RAM), dynamic random access memories (DRAM), static random access memories (SRAM), and other forms of volatile memories. In some examples, memory 104 is used to store program instructions for execution by processor 102. Memory 104, in one example, is used by software, applications, or data models running on the application modernization assessment system 100 (e.g., by a computer-implemented data processing module) to temporarily store information during program execution.

Memory 104, in some examples, also includes one or more computer-readable storage media. The memory can be configured to store larger amounts of information than volatile memory. The memory can further be configured for long-term storage of information. In some examples, the memory includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device. For example, user interface 106 can be configured to administer questions to a stakeholder and/or obtain response data from the stakeholder regarding an application and/or an organization. User interface 106 can include one or more of a sound card, a video graphics card, a speaker, a display device (such as a liquid crystal display (LCD), a light emitting diode (LED) display, an organic light emitting diode (OLED) display, etc.), a vibration or rumble motor, an accelerometer, a touchscreen, a keyboard, a mouse, a joystick, or other type of device for facilitating input and/or output of information in a form understandable to users and/or machines.

Application modernization assessment system 100 is a computing device configured to perform one or more methods described herein. Application modernization assessment system 100 can accept data from and/or can be operably connected to a server and/or a database. Application modernization assessment system 100 can use data from the server and/or database to assess application modernization information. More generally, application modernization assessment system 100 is configured to perform any of the functions attributed herein to an application modernization assessment system, including receiving an output from any source referenced herein and generating and providing data and information as referenced herein.

Application modernization assessment system 100 can be a discrete assembly or be formed by one or more devices capable of individually or collectively implementing functionalities and generating and outputting data as discussed herein. In some examples, application modernization assessment system 100 can be implemented as a plurality of discrete circuitry subassemblies. In some examples, application modernization assessment system 100 can include or be implemented at least in part as a smartphone or tablet, among other options. In some examples, application modernization assessment system 100 and/or user interface 106 of application modernization assessment system 100 can include and/or be implemented as downloadable software in the form of a mobile application. The mobile application can be implemented on a computing device, such as a personal computer, tablet, or smartphone, among other suitable devices. Application modernization assessment system 100 can be considered to form a single computing device even when distributed across multiple component devices.

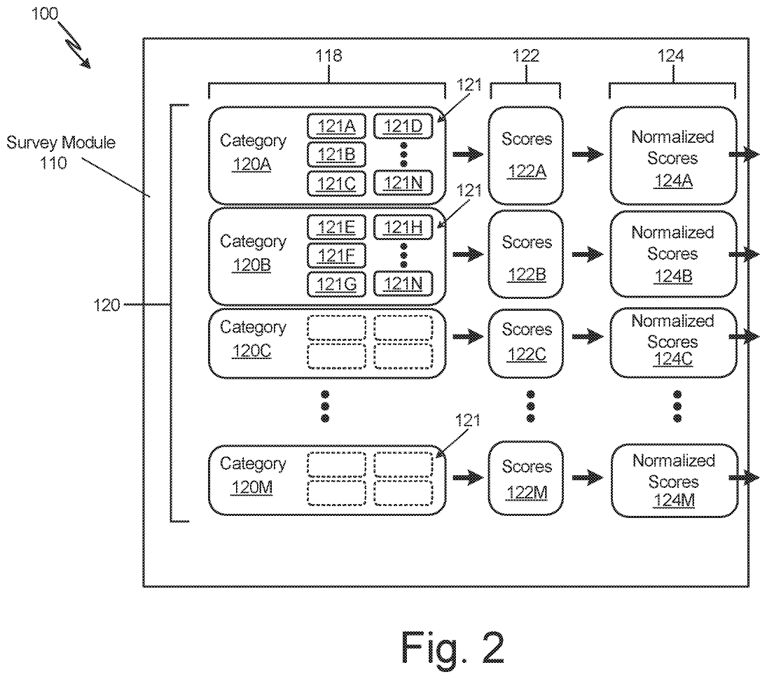

FIG. 2 is block diagram illustrating example modules, data structures, and operational sequences of survey module 110, which interfaces with an organization to gather information relating to one or more applications and organization preferences. Survey module 110 includes questions 118. Each question from the group of questions 118 can be designed to elicit information from one of categories 120A, 120B, and up to an arbitrary number of categories 120M (“M” denoting an arbitrary number). One or more of categories 120A-120M may further be divided into one or more subcategories 121A, 121B, and up to an arbitrary number of subcategories 121N (“N” denoting an arbitrary number that is not necessarily equal to the arbitrary number of categories “M,” and which can be greater than, equal to, or less than the arbitrary number of categories “M”). In some examples, survey module 100 can include organization-specific questions, application-specific questions, or a mix of organization-specific questions and application-specific questions, which are used by system 100 to define characteristics of each application and the modernization preferences and/or migration preferences of the organization. Questions 118 are closed-form questions in which each question 118 is associated with a fixed set of responses rather than an unlimited (i.e., open) response field. Some or all of questions 118 can be associated with the same set of responses. In other examples, at least one or more of questions 118 has a fixed set of responses that is different from response sets of other questions 118. Responses within each set of questions 118 are assigned an individual score 122, illustrated in the example of FIG. 2 as scores 122A-122M, with M representing an arbitrary number.

Organization-specific questions may relate to an organization's desire to innovate, cost of innovation, risk tolerance, market risk, market differentiation, market position and/or competitors, among other potential questions. Questions directed to an organization's desire to innovate can include, in some examples, whether the organization uses primarily old or new technologies, whether the organization prefers efficiency over innovation and vice versa, or other questions related to an organization's desire (or inclination) to innovate. An organization's desire to innovate may also depend on whether the organization has a niche or broad market share. The organization's costs associated with innovation include, for example, the presence or absence of legal obligations and/or regulations or the adherence to industry standards that are required to operate. An organization's risk probability can increase or decrease based on the degree of market differentiation and market maturity, as well as the number of competitors within the market. Questions directed to financial risk and security risk, among other questions, can characterize an organization's risk tolerance.

Applications can include software or other computer-implemented aggregations of functionality that are utilized by an organization to accomplish one or more tasks of a workload. Examples of applications can include an Enterprise Resource Planning (ERP) software tool, a cost or invoice tracking software package, a projection management software program, other software, or other computer-implemented programs or tools. Application-specific questions may relate to an application's architecture, framework, value, operational risk, and/or operational costs, as well as an application's potential for innovation, migration options, and costs of migration. Questions directed to the application type, application priority, technologies used by the application, the application's lifecycle, and the availability of alternative or duplicate applications that perform the same workload help define the scope and cost of application migration.

Application value can be elicited by questions directed to the application's technical and sales impact and the degree of market differentiation between the application and other applications within the market. The quantity of application users and revenue generated by leveraging the application are indicative of application value. Whether or not the application is partner-facing, vendor-facing, and/or customer-facing, as well as the degree of application alignment with an organization's goals can also describe an application's value to the organization. Questions pertaining to the time for an application to reach stable operation, the difficulty making changes to the application, and the frequency of new releases are examples of questions that may correspond to or otherwise characterize an application's time to market, which may increase or decrease the application's value. Similarly, questions characterizing the ability to innovate or improve the application include the number of help desk calls pertaining to the application, the training effort required to use the application, and the cost of hosting the application. Additional factors influencing an application's ability to innovate can include whether the hosting arrangement matches current and future requirements, and the effort required to support the application. Questions providing information about the existence or absence of issues related to scaling the application or application performance, as well as the existence of useability, stability, or global support issues, also increase or decrease an application's value.

Application value can be elicited by questions directed to the application's technical and sales impact and the degree of market differentiation between the application and other applications within the market. The quantity of application users, revenue generated by leveraging the application, whether or not the application is partner-facing, vendor-facing, and/or customer-facing, and degree of application alignment with an organization's goals also describe an application's value. Questions pertaining to the time for an application to reach stable operation, the difficulty making changes to the application, and the frequency of new releases may characterize an application's time to market and may increase or decrease the application's value. Similarly, questions characterizing the ability to innovate or improve the application can include the number of help desks calls pertaining to the application, the training effort required to use the application, the cost of hosting the application, whether the hosting arrangement matches current and future requirements, and the effort required to support the application. Questions providing information about the existence or absence of issues related to scaling the application or application performance, as well as the existence of useability, stability, or global support issues also increase or decrease an application's value.

The type of response data and/or the number of potential responses to questions 118 can vary from question to question. In some instances, questions 118 may elicit a response among a range of integers. In other examples, responses can be a fixed set of textual responses such as true/false, never/sometimes/always, strongly disagree/sometimes disagree/neutral/sometimes agree/strongly agree, and the like. In some instances, textual responses are converted to an integer value, e.g., within a range of integer values. For example, a true-false question may receive a “0” for false and a “5” for true. A never-sometimes-always question may receive a “0” for never, a “3” for sometimes, and a “5” for always. A disagree-neutral-agree question may receive a “0 for strongly disagree, a “1” for sometimes disagree, a “2” for neutral, a “3” for sometimes agree, and a “4” for strongly agree. It should be understood, however, that any range of scores can be applied to textual and numeric response data as long as the question wording and corresponding responses are consistent. For example, questions within a category (or subcategory) having a higher score may represent aspects of the application having relatively higher value than questions with lower scores within the same category and/or subcategory. The range of scores 122 for each question may be the same or different.

Whether or not the range of scores 122 for each question differ, scores 122 can be normalized to a common range of scores (i.e., a normalized score 124). In some examples, normalized score 124 can be any value between zero and one, although, normalized score 124 can be associated with any range common to all questions 118. Normalized score 124 is calculated as the quotient in which the numerator is the response value, X, minus the minimum score of the question, Xₘᵢₙ, and the denominator is the maximum score, Xₘₐₓ, minus the minimum score of the question, Xₘᵢₙ.

As depicted in FIG. 2, survey module 110 includes a question set that includes an arbitrary number of questions 118. Responses to questions 118 are obtained from one or more stakeholders within organization for one or more applications. Questions 118 are categorized into at least one of three categories 120A, 120B, and 120C and up to an arbitrary number “M” of categories. Each of categories 120A and 120B are further subdivided into one of subcategories 121. Category 120A includes a subset of organization-specific questions 118, which are designed to elicit information about the organization's desire to innovate (subcategory 121A), cost of innovation (subcategory 121B), probability of market risk (subcategory 121C), and risk tolerance (subcategory 121D). Categories 120B and 120C contain subsets of application-specific questions 118, each subset designed to elicit information about a particular application. A subset of questions 118 within category 120B is directed to an application's value. A portion of questions 118 within category 120B are designed to elicit information about an application's potential value (subcategory 121E), time to market (subcategory 121F), ability to innovate (subcategory 121G), and application risk (subcategory 121H). Category 120C includes a subset of questions 118 related to application migration scope (i.e., aspects of the application affecting the available application migration and/or modernization options).

Organization-specific questions 118 directed at an organization's desire to innovate (subcategory 121A of category 120A) include whether the organization uses primarily new or old technology, or a mix of new and old technology. Further, determining whether the organization prioritizes efficiency over innovation or innovation over efficiency helps to quantify the organization's desire to innovate. The costs of innovation are quantified by questions 118 within subcategory 121B. Example questions 118 of subcategory 121B aim to quantify the costs associated with legal obligations, regulations, and/or industry standards. Risk probabilities are quantified using questions 118 within subcategory 121C. Example risk probability questions quantify the degree of market differentiation between the organization's application and other applications within the market. Risk probability questions may also quantify the market maturity. Subcategory 121D includes questions 118 to quantify an organization's financial risk and/or security risk tolerance.

Application value is evaluated using category 120B questions. Example questions that may be used to quantify an application's potential value (subcategory 121E) include questions directed application technical and/or sales impact on the market, the degree of differentiation between the application and other applications within the same market, the number of users, and whether the application is aligned with goals and/or value s of the organization. Additional factors influencing an application's potential value include whether the application is vendor-facing, partner-facing, or customer-facing. Questions quantifying the application's time to market (subcategory 121F) and ability to innovate (subcategory 121G) may increase or decrease the application's value. For instance, applications that are quicker to market or easier to maintain may increase an application's potential value. Applications that are more frequently released into the market may also influence or affect an application's time to market and hence potential value. Questions aimed to quantify an application's ability to innovate (subcategory 121G) or potential for improvement include quantifying the number of help desk or support calls/tickets for the application. Whether an application requires extensive training or basic training may help quantify an application's ability to innovate. The ease or difficulty with which an application can be scaled may contribute to an application's ability to innovate. An application's ability to innovate is also affected by the application stability issues, useability issues, security issues, and performance issues. Questions 118 designed to quantify application risk (subcategory 121H) include questions quantifying the impact of compliance or regulations on the application, impact of downstream applications, and the complexity of the application.

Questions 118 within category 120C define the scope of potential application migration options. In some examples, category 120C questions 118 inquire about the type of application. Application types can include high-code (e.g., applications programs in JavaScript), low-code, software-as-a-service (SaaS), and commercial off-the-shelf (COTS) applications, among other options. Category 120C questions quantify the application priority, or how important the application is to a workload. Questions 118 of category 120C may also determine whether alternative or replacement SaaS applications exist and whether the organization employs multiple applications for the same or similar workload. Questions 118 within category 120C may also investigate which technologies (e.g., java, ruby on rails, PHP, .net, or mainframe technologies) are used by the application that may limit or determine which migration options are available.

The stage of the application's lifecycle is also important to evaluating migrations options. Application lifecycle stages include, in order of early stages to late stages: ideation, pre-rollout, minimum viable product, off-boarding, and retired. An application with a defined function and without any code associated with it is in the ideation stage. Once coding begins and before a functional application is obtained, an application is in the pre-rollout stage. An application reaches the minimum viable product stage at its initial release, although further development may occur to the application following this release. A mature application is fully developed and regularly performs workloads for an organization. Off-boarding applications are any application that the organization is working to remove from a workload. A retired application is not used for any workload of the organization.

Responses collected from questions 118 of any category 120A, 120B, and 120C and any subcategory 121A, 121B, 121C, 121D, 121E, 121F, and 121G are assigned a score 122. Scores 122 are integers greater than or equal to a minimum score and less than or equal to maximum score. The range of scores 122 for each question can be the same or different. For some questions, the score 122 is directly assigned from the response (e.g., a question ranking an aspect of the organization or application on a scale from “0” to “5”). For other questions 118, textual responses are converted to a score 122. Survey module 110 produces normalized scores 124 based on scores 122 such that each normalized score 124 ranges between the same minimum normalized score and maximum normalized score. For example, normalized scores 124 can equal a value between 0 and 1, although other ranges can be used by other examples.

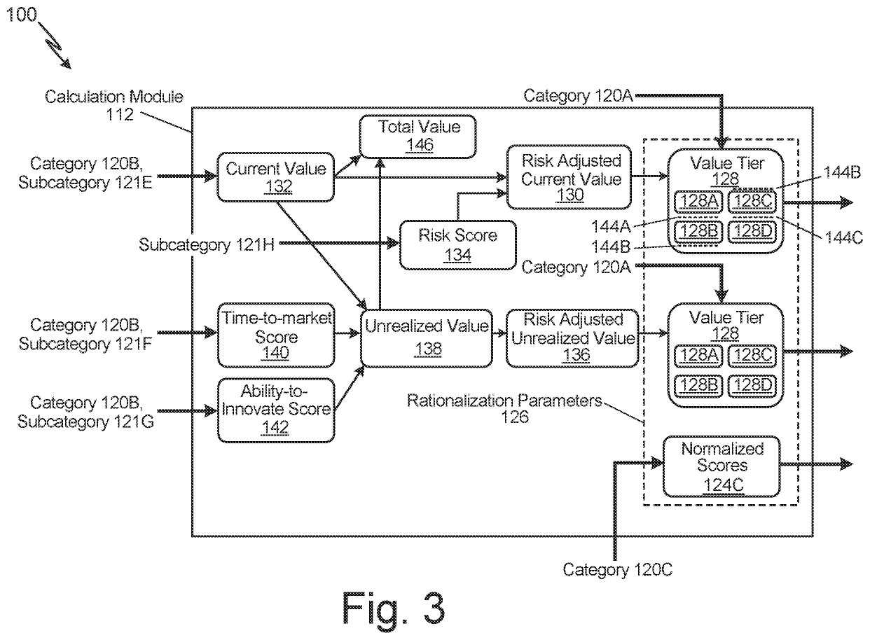

FIG. 3 is a block diagram of calculation module 112. Normalized scores 124 are output to calculation module 112, which uses normalized scores 124 to determine one or more rationalization parameters 126. Rationalization parameters 126 are quantities that are indicative a particular disposition and/or limit the available dispositions for a given application. As depicted by FIG. 3, rationalization parameters 126 include value tiers 128 and responses from one or more questions 118 evaluating migration scope (category 120C). Other examples may use different rationalization parameters 126 such as one or more of risk-adjusted current value 130, current value 132, risk score 134, risk-adjusted unrealized value 136, unrealized value 138, time-to-market score 140, ability-to-innovate score 142, and response data from one or more questions 118 of a particular category 120 and/or subcategory 121.

In the example shown, system 100 includes four value tiers 128A, 128B, 128C, and 128D. The highest or first value tier 128A encompasses applications with the highest value and greatest alignment with the organization's preferences and values. The lowest or fourth value tier 128D includes applications with the lowest value and the least alignment with the organization's preferences and values. Intermediate tiers (i.e., second value tier 128B and third value tier 128C) have intermediate values and partial alignment with the organization's preferences and values, albeit to a different degree. Second value tier 128B contains applications with greater value and alignment with the organization's preferences and values than applications classified within third value tier 128C. System 100 classifies the application into one of a value tiers 128A, 128B, 128C, and 128D, which define application groups with decreasing value and organizational alignment from the highest or first value tier 128A to the lowest or fourth value tier 128D.

Classification of the application into one of value tiers 128A, 128B, 128C, and 128D includes determining a risk-adjusted current value 130 of an application based on current value 132 and risk score 134. Additionally, applications may be classified into one of value tiers 128A, 128B, 128C, and 128D based on a risk-adjusted unrealized value 136, which is derived from unrealized value 138 and risk score 134. Unrealized value 138 is derived from current value 132, time-to-market score 140, and ability-to-innovate score 142. Value tiers 128A, 128B, 128C, and 128D are defined by tier thresholds 144A, 144B, and 144C, which are determined based on organization-specific questions 118 of category 120A.

Current value 132 of an application can be determined based on normalized scores 124 of questions 118 directed to application value (category 120B) of survey module 110. In some examples, current value 132 can equal a summation of normalized scores 124 produced by potential application value questions (subcategory 121E).

Risk score 134 of an application is determined based on normalized scores 124 of questions 118 directed to application risk (subcategory 121H). For example, the presence or absence of regulations that impact the operation of the application increase or decrease application risk. Increased application risk occurs when downstream applications depend on the functionality or output of the application to complete the workload. In this instance, failure of the application may cause other applications downstream from the present application to fail. Complexity of an application also affects application risk, increased complexity generally associated with increased risk and decreased complexity associated with decreased risk. The risk score 134 of an application can be equal to a mathematical mean, mode, median, or other central tendency of normalized scores 124 of questions 118 direct to application risk (subcategory 121H). The risk-adjusted current value 130 is equal to current value 132 divided by risk score 134.

The time-to-market score 140 quantifies how quickly and how frequently an application is released in the market. The time-to-market score 140 can be quantified by a mathematical mean, mode, median, or other central tendency of normalized scores 124 from subcategory 121F. The ability-to-innovate score 142 quantifies unrealized opportunities stemming from application deficiencies. Resolving or improving application deficiencies may produce additional output by the application. The ability-to-innovate score 142 can be quantified by a mathematical mean, mode, median, or other central tendency of normalized scores 124 obtained from subcategory 121G.

Unrealized value 138 represents an increase in application value that could be achieved if application deficiencies are addressed. Accordingly, total value 146 of an application equals current value 132 plus unrealized value 138. Unrealized value 138 of an application can be characterized by the product of current value 132 and a summation of the inverse of time-to-market score 140 and the inverse of ability-to-innovate score 142. Risk-adjusted unrealized value 136 of an application is the unrealized value 138 divided by risk score 134.

Calculation module 112 assigns a value tier selected from value tiers 128A, 128B, 128C, and 128D to the application by separately comparing risk-adjusted current value 130 and risk-adjusted unrealized value 136 to tier thresholds 144A, 144B, and 144C. If risk-adjusted current value 130 (or risk-adjusted unrealized value 136) is greater than threshold 144A, calculation module 112 assigns highest value tier 128A to the application. If risk-adjusted current value 130 (or risk-adjusted unrealized value 136) is less than or equal to threshold 144A and greater than threshold 144B, calculation module 112 assigns intermediate (or second) value tier 128B to the application. Applications having risk-adjusted current values 130 (or risk-adjusted unrealized values 136) less than or equal to threshold 144B and greater than threshold 144C are assigned intermediate (or third) value tier 128C by calculation module 112. For risk-adjusted current values 130 (or risk-adjusted unrealized values 136) less than or equal to threshold 144C and greater than zero are assigned lowest (or fourth) value tier 128D.

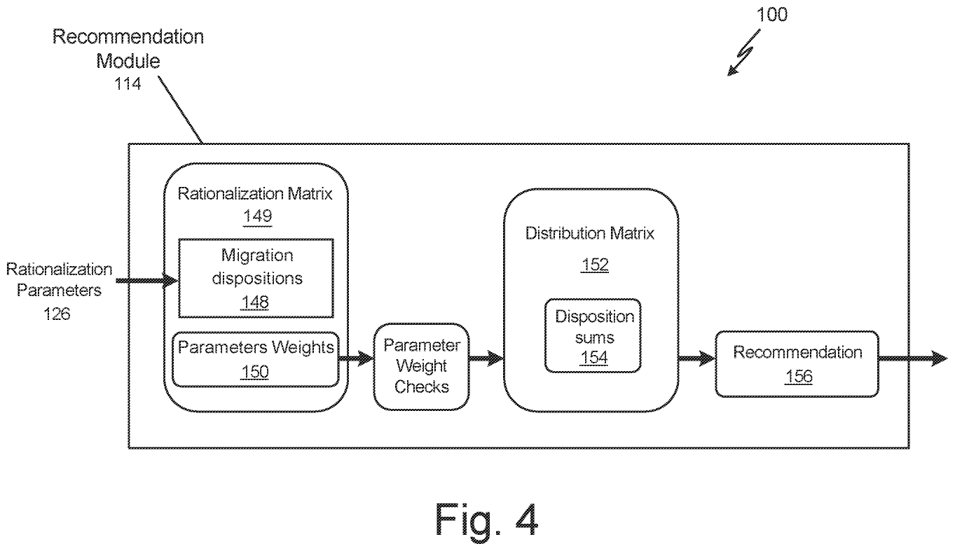

FIG. 4 is a block diagram of recommendation module 114 that produces migration disposition 148 based on one or more rationalization parameters 126. Recommendation module 114 includes rationalization matrix 149 populated with parameter weights 150 and disposition matrix 152 populated with disposition sums 154. Rationalization matrix 149 relates each potential value of each rationalization parameter 126 to each mitigation disposition 148. Depending on the parameter weight 150, certain rationalization parameters 126 deprioritize some of the potential migration dispositions 148 while other rationalization parameters 126 may deprioritize all but one potential migration dispositions 148. For each rationalization parameter 126, weights 150 may define a distribution with respect to migration dispositions 148. In some instances, the weights 150 may bias some migration dispositions 148 over other migration dispositions 148.

Migration dispositions 148 represent a potential migration recommendation for a given application provided to the organization. Dispositions 148 include retire, retain, replace, rehost, refractor, rearchitect, and reenvision. For applications assigned the “retire” disposition, module 114 recommends that use of the application is stopped and the application removed from the organization's portfolio. The “retain” disposition recommends to the organization that an application remain is use and in its current form. The “replace” disposition informs the organization that the application is removed from the organization's portfolio and replaced with another application. For example, certain applications may be migrated to software-as-a-service (SaaS) or commercial-off-the-shelf (COTS) applications. Applications that receive the “rehost” disposition can be migrated to a server, cloud-based service, or virtualized container architecture. The “refactor” disposition recommends that an application is revised without altering the application's external behavior. The “rearchitect” disposition may be provided to application that are incompatible with cloud-services and recommends that an application is rewritten for compatibility with such cloud-service. The “reenvision” disposition recommends that an organization rewrite an application from scratch.

Rationalization matrix 149 is a multi-dimensional matrix (e.g., a two-dimensional matrix or other matrix having two or more dimensions) that relates rationalization parameters 126 to each migration disposition 148 as a function of parameter weights 150. In the depicted example, rationalization parameters 126 include migration scoping questions 118 from category 120C, value tiers 128 assigned based on risk-adjusted current value 130, and value tiers 128 assigned based on risk-adjusted unrealized value 136. Parameter weights 150 can be any real number. In some cases, parameters weights 150 are real numbers between zero and one, inclusive. In other cases, some or all of parameter weights 150 can be real numbers between zero and a number greater than one. For equally weighted rationalization parameters, parameters weights 150 are real numbers between zero and the same upper limit. In other examples, certain rationalization parameters 126 or, more specifically, certain values of rationalization parameters 126 can be more heavily weighted than other rationalization parameters 126 by employing parameter weights 150 with greater absolute values.

In a more specific example, rationalization matrix 149 can include five migration scoping questions 118 from category 120C, each question having multiple possible responses. For example, a first migration scoping question can determine an application type selected from at least: software-as-a-service (SaaS), commercial-off-the-shelf (COTS), low-code, and high-code. The second migration scoping question ranks application priority on a scale from 1 (highest priority) to 5 (lowest priority). The third migration scoping question evaluates whether an application has replacement options and ranks replacement options on a scale from “0” (no replacement options) to “5” (numerous replacement options). The fourth migration question limits the available migration dispositions 148 based on the technologies (e.g., java, .net, PHP, ruby on rails, mainframe, sharepoint) implemented by the application. The fifth migration limits the available migration dispositions 148 based on the application's lifecycle stage (e.g., ideation, pre-rollout, minimum viable product, mature, off-boarding, and retired). For each response to the first, second, third, fourth, and fifth migration questions, a parameter weight 150 corresponding to each migration disposition 148 is assigned.

The depicted example classifies an applications risk-adjusted current value 130 and risk-adjusted unrealized value 136 into one of four value tiers 128A, 128B, 128C, and 128D. Each tier 128A, 128B, 128C, and 128D associated with risk-adjusted current value 130 and each tier 128A, 128B, 128C, and 128D associated with a risk-adjusted unrealized value 136 has parameter weights 150 corresponding to each migration disposition 148.

The disposition matrix 152 produces disposition recommendation 156 based on disposition sums 154 corresponding to each migration disposition 148. Disposition sums 154 equal a summation of parameter weights 150 corresponding to each migration disposition 148. Parameter weights 150 are determined based on rationalization parameters 126, which are determined via survey module 110 or calculation module 112. Certain rationalization parameters 126 can be omitted from disposition sum 154 if those rationalization parameters 126 do not distinguish one disposition over the remaining migration dispositions 148. For example, a rationalization parameter 126 can be omitted from disposition sum 154 if the parameter weights 150 associated with the rationalization parameter 126 are nonzero and equal to each other (i.e., the parameter weight 150 for a given rationalization parameter 126 is the same for each migration disposition 148). A migration disposition 148 is not viable and cannot be recommended if at least one parameter weight 150 for a given migration disposition 148 is zero. The migration disposition 148 with the largest disposition sum 154 is output by disposition matrix 152 as the disposition recommendation 156.

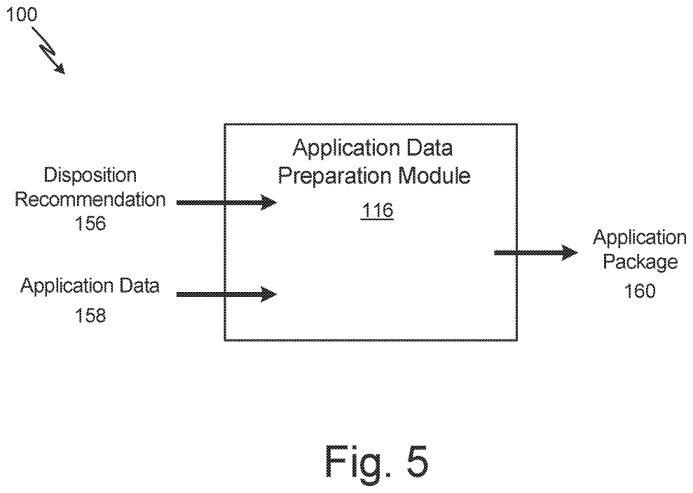

FIG. 5 is a block diagram of application data preparation module 116, which compiles, and pre-processes application data 158 associated with an application based on disposition recommendation 156. Application data 158 can include application source code, installation files, configuration files, application programming interfaces (APIs), user account information, network or cloud location of databases, information contained within databases, business data, business process information and associated code, and source system data, and/or target system data, which can include server and/or virtual machine location, IP address, and associated hardware and/or platform services. Further, application data 158 can include license information, training information, and/or information required or useful to validate proper operation of the application, and other information and/or metadata related to the application.

Application data preparation module 116 prepares application package 160 based on disposition recommendation 156. For example, application package 160 can include user account information and an end-of-life date in situations where disposition recommendation 156 is “retire”. In this situation, application package 160 may include a migration script or other programming required to notify users of the application's end-of-life date. In another example, an application may receive a “retain” disposition recommendation in which application package 160 may contain reasons for retaining an application. In yet another example, an application may receive a disposition recommendation of “replace”. In such examples, application package 160 can contain a list of alternative applications that can perform the workload and associated license information. Application package 160 may further contain location and IP addresses of target hardware and/or platform services associated with the current application as well as like information for the source application. Application package 160 may also contain business data and/or business processes, which may be associated with custom code and/or scripts that transform user and/or database data of the source application into a format associated with the target application, among other possible things. In an example in which the disposition is “rehost”, application package 160 can include user account information, network location of associated databases containing the user account information as well as other related application information, target network and/or web location for rehosted application, and configuration files, among other possible information. For applications receiving a “refactor”, “rearchitect”, or “reenvision” recommendation, application package 160 may include application source code in addition to application configuration files, user account information, database locations, and other related information in addition to any of the information described above.

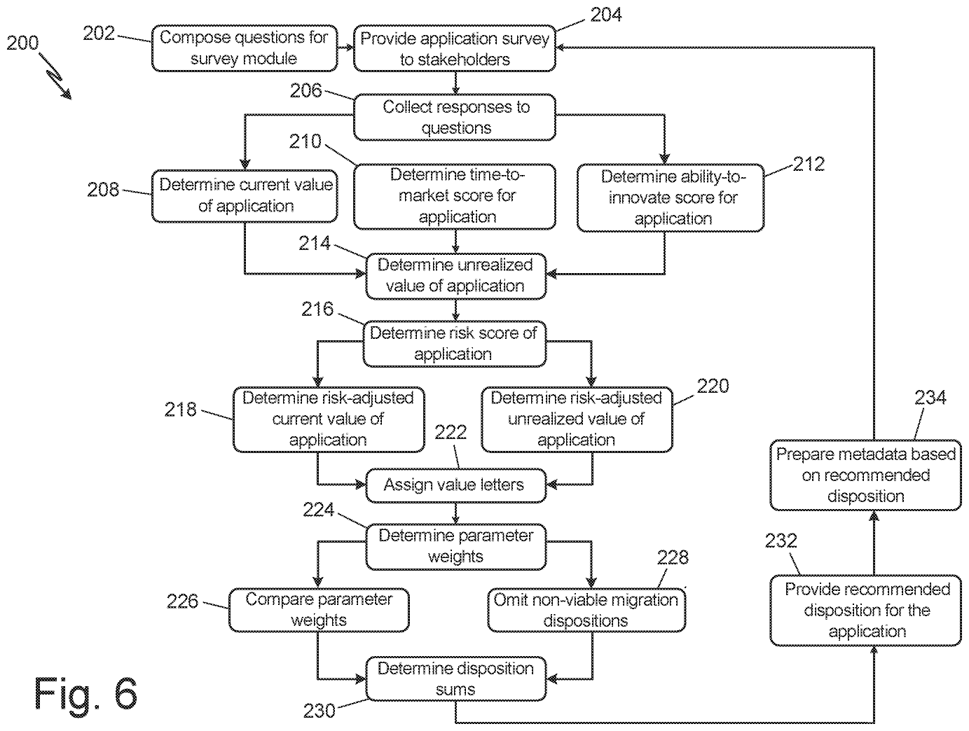

FIG. 6 is a flowchart describing a method of preparing application data based on a migration recommendation using system 100. The sequence depicted is for illustrative purposes only and is not meant to limit the method 200 in any way as it is understood that the portions of the method can proceed in a different logical order, additional or intervening portions can be included, or described portions of the method can be divided into multiple portions, or described portions of the method can be omitted without detracting from the described above. Method 200 includes steps 202, 204, 206, 208, 210, 212, 214, 216, 218, 220, 222, 224, 226, 228, 230, and 232.

In step 202, a user of system 100 composes a set of questions 118 for survey module 110. Questions 118 are categorized into two or more categories 120. At least one of categories 120 includes organizational-specific questions 118 while at least one of categories 120 includes application-specific questions 118. One or more categories 120 can be further organized into one or more subcategories 121. Questions 118 are closed-form, meaning that each question 118 is associated with a fixed set of responses. Each set of responses for each of questions 118 is then associated with a range of scores 122.

In step 204, the survey is provided to stakeholders within the organization for an application. In step 206, responses to questions 118 are collected from one or more stakeholders associated with an organization for a given application. Responses to each question 118 are combined from all stakeholders within the organization and normalized to a common range, which are passed to calculation module 112.

In steps 208, 210, 212 and 214, the calculation module determines current value 132, time-to-market score 140, ability-to-innovate score 142, and unrealized value 138, respectively. In step 216, the calculation module determines risk score 134. Risk-adjusted current value 130 and risk-adjusted unrealized value 136 are determined in steps 218 and 220. In step 222, calculation module 112 assigns value tiers 128 to the application based on the risk-adjusted current value 130 and the risk-adjusted unrealized value 136.

In step 224, the recommendation module 114 determines parameter weights 150 associated with each rationalization parameter 126 using rationalization matrix 149. In step 226, the parameter weights 150 for each rationalization parameter 126 are compared to each other. Rationalization parameters 126 are omitted from the disposition sum 154 if weighted parameters 150 of the rationalization parameter 126 are equal (i.e., the maximum parameter weight equals to minimum parameter weight for a given rationalization parameter). In step 228, any migration disposition 148 in which one of the rationalization parameters is zero is not a viable disposition and are removed from the set of potential migration dispositions. In step 230, the parameter weights for the remaining rationalization parameters are summed for each of the remaining migration dispositions. In step 232, the disposition sums are compared to each other and the recommendation module 114 outputs a disposition recommendation 156.

In step 234, application data preparation module 116 compiles and preprocesses application data 158 based on the disposition recommendation 156. Compiling can include aggregating application data 158 from multiple sources into application package 160. Preprocessing application data 158 can include generating one or more migration scripts (or other automated process). A migration script can be assembled by application data preparation module 116 from a group of preexisting generalized code blocks. Migration scripts are configured to perform at least a portion of a migration workload associated with an application. For example, migration scripts can be configured to reformat application data 158 into a format compatible with the disposition recommendation. In other examples, migration scripts can be configured to scan an application's source code and/or configuration files to automatically modify the source code and/or configuration files to mitigate security issues and/or correct compatibility issues of an application. In other instances, migration scripts can be configured to automatically assemble to aggregate user data and automatically assemble and send notifications or other information to an application's users. In each example, application preparation module 116 generates application package 160 based on disposition recommendation 156.

For example, upon receiving a “retire” disposition recommendation, application data preparation module 116 can be configured to automatically aggregate user data and an end-of-life date associated with an application. User data can include, among other things, user identities, user login credentials, and user email and/or other contact information. Using aggregated application data 158, application data preparation module 116 may prepare a migration script or other automated process that, when executed by computing systems of the organization, communicates to each user the end-of-life date for the application via email or other communication means.

In another example in which an application receives a “retain” disposition, application data preparation module 116 can be configured to retrieve a rationale for retention from one or more stakeholders. The retention rationale can be kept by the organization for reference and/or subsequent rationalization determinations. In this instance, a migration script or other program automatically prepared by application data preparation module 116 can be configured to send an email or other communication to one or more stakeholders. After receiving at least one response from a stakeholder that articulates the retention rationale, the migration script or other program can be configured to store the rationale using a computing system of the organization.

Application data preparation module 116 can be configured to aggregate additional information for applications that receive a “replace” disposition. For instance, application data preparation module 116 may aggregate licensing information associated with a current application and licensing information associated with a replacement application in addition to user data (e.g., user identities, user login credentials, and user email and/or other data primarily associated with users of the application). Application data preparation module 116 may also aggregate business information, which can include, among other things, customized financial and/or sales calculations, business logic, and/or computing workloads). Using the user data, application data preparation module 116 can be configured to automatically prepare a migration script or other program that converts licenses of the current application to licenses of the target application. Additionally, the migration script or other program can automatically customize the target application according to the organization's business information, incorporating customized calculations, business logic, and/or workloads into the target application. Customization of the target application can occur by modifying or creating configuration files associated with the target application. Further, application data preparation module 116 can configure the migration script or other program such that users are automatically notified of a migration date via email or some other communication means.

In another example, a “rehost” disposition can cause application data preparation module 116 to aggregate host type (e.g., bare metal server, virtual machine, or container) and host location of an application's current host and target host. Further, application data preparation module 116 can be configured to aggregate configuration files associated with the current host and to identify methodology of implementing the move from the current host to the target host. In this instance, a migration script or other program prepared automatically by the application data preparation module 116 can include a sequence for provisioning virtual machines and/or containers at the target location, which can be on-premise servers and/or cloud-based providers.

Upon receiving a “refactor” disposition recommendation, application data preparation module 116 can be configured to retrieve source code and/or database information associated with an application. In this instance, application data preparation module 116 may automatically prepare a migration script or other program that scans the source code and/or database for work items, each work item required for application migration (e.g., from an on-premise server to a cloud-based provider). Work items can include rewriting the source code to mitigate known security issues and/or eliminate application functions that are not supported by the cloud-based provider. Other work items can include reformatting data stored within database to be compatible with the cloud-based provider.

In another example in which an application receives a “rearchitect” disposition recommendation, application data preparation module 116 can be configured to retrieve source code and/or database as well as an organization's business information (e.g., customized financial and/or sales calculations, business logic, and/or computing workloads). In this instance, an application is broken apart and reprogrammed using modernized techniques without altering the underlining business rules and/or customized calculations. Accordingly, application data preparation module 116 may automatically prepare a statement of work that describes an organization's computational workloads and/or other business information for the application slated for rearchitected.

In another example, application data preparation module 116 may receive a “re-envision” disposition recommendation. When an application is re-envisioned, the application is recreated and may include modified or new computing workloads or other business information. In this case, application data 158 aggregated by application data preparation module 116 can include business information (e.g., customized financial and/or sales calculations, business logic, and/or computing workloads), documentation associated with business information, user data (e.g., user identities, login credentials, email addresses, or other contact information), and key transition dates, among other possible data and information. Using application data 158, application data preparation module 116 may automatically prepare a statement of work describing the transition from the current application to the re-envisioned application.

Steps 204, 206, 208, 210, 212, 214, 216, 218, 220, 222, 224, 226, 228, 230, 232 and 234 can be repeated for additional applications within an organization's portfolio. Current value 132, risk score 134, unrealized value 138, time-to-market score 140, ability-to-innovate score 142 for each application can be compared to corresponding values or scores of another application within the application's portfolio.

### Discussion of Non-Exclusive Examples

The following are non-exclusive descriptions of possible embodiments of the present invention.

Method for Automatically Preparing Application Data for Migration

A method of using a computing device to prepare application data for migration according to an example embodiment of this disclosure includes, among other possible steps, collecting survey responses to a plurality of closed-form questions and assigning a score to each of the survey responses to define a plurality of scores. Each of the questions is configured to elicit a survey response from one of a plurality of categories. The method further includes determining a normalized score associated with each of the plurality of scores to define a plurality of normalized scores. Each of the plurality of normalized scores range from a minimum normalized score to a maximum normalized score. The method further includes determining a plurality of rationalization parameters. Each of the rationalization parameters is based on a different subset of normalized scores associated with one of the plurality of categories. The method further includes determining a migration recommendation based on the rationalization parameters and automatically preparing an application package associated with the application based on the migration recommendation.

The method of the preceding paragraph can optionally include, additionally and/or alternatively, any one or more of the following features, configurations, additional components, and/or steps.

A further embodiment of the foregoing method, wherein preparing the application package can include aggregating, by the computing device, a plurality of data files into the application package.

A further embodiment of any of the foregoing methods, wherein preparing the application package can include generating, by the computing device, one or more migration scripts that are executed to perform at least a portion of a migration workload.

A further embodiment of any of the foregoing methods, wherein the plurality of categories can include an organization category relating to migration preferences of the organization, an application value category relating to a value of the application, a rationalization cost category relating to a cost of migrating the application, and a migration scoping category relating to feasibility of a plurality of potential migration recommendations.

A further embodiment of any of the foregoing methods, wherein each of the plurality of scores can be an integer between a minimum integer and a maximum integer inclusive.

A further embodiment of any of the foregoing methods, wherein determining the plurality of rationalization parameters can include determining, by the computer device, a current value of the application based on a first subset of normalized scores associated with the application value category.

A further embodiment of any of the foregoing methods, wherein determining the plurality of rationalization parameters can include a time to market score of the application based on a second subset of normalized scores associated with the application value category.

A further embodiment of any of the foregoing methods, wherein determining the plurality of rationalization parameters can include determining, by the computing device, an ability to innovate score based on a third subset of normalized scores associated with the application value category.

A further embodiment of any of the foregoing methods, wherein determining the current value of the application can include determining, by the computing device, a first mean of the first subset of normalized scores.

A further embodiment of any of the foregoing methods, wherein determining the time-to-market score can include determining, by the computing device, a second mean of the second subset of normalized scores.

A further embodiment of any of the foregoing methods, wherein determining the ability to innovate score can include determining, by the computing device, a third mean of the third subset of normalized scores.

A further embodiment of any of the foregoing methods, wherein determining the plurality of rationalization parameters can include determining, by the computing device, an unrealized value of the application based on the current value, the time-to-market score, and the ability-to-innovate score.

A further embodiment of any of the foregoing methods, wherein the unrealized value can equal a produce of the current value and a summation of an inverse of the time-to-market score and an inverse of the ability-to-innovate score.

A further embodiment of any of the foregoing methods, wherein determining the plurality of rationalization parameters can include determining, by the computing device, an application risk score based on a fourth subset of normalized scores associated with the application value category.

A further embodiment of any of the foregoing methods, wherein determining the application risk score can include determining, by the computing device, a sum of the fourth subset of normalized scores.

A further embodiment of any of the foregoing methods, wherein determining the plurality of rationalization parameters can include determining, by the computing device, a risk-adjusted current value equal to the current value divided by the application risk score.

A further embodiment of any of the foregoing methods, wherein determining the plurality of rationalization parameters can include determining, by the computing device, a risk adjust unrealized value equal to the unrealized value divided by the application risk score.

A further embodiment of any of the foregoing methods, wherein determining the plurality of rationalization parameters can include determining, by the computing device, a current value tier and an unrealized value tier.

A further embodiment of any of the foregoing methods, wherein the current value tier can be greater than or equal to a minimum tier threshold and less than a maximum tier threshold.

A further embodiment of any of the foregoing methods, wherein the minimum tier threshold and the minimum tier threshold can be determined based on a fifth subset of normalized score corresponding to the organization category.

A further embodiment of any of the foregoing methods, wherein determining the migration recommendation can include assigning a plurality of disposition weights.

A further embodiment of any of the foregoing methods, wherein each disposition weight can correspond to one of the plurality of potential migration dispositions and one of the plurality of rationalization parameters.

A further embodiment of any of the foregoing methods, wherein determining the migration recommendation can include determining, by the computing device, a plurality of disposition sums.

A further embodiment of any of the foregoing methods, wherein each disposition sum can be equal to a sum of disposition weights associated with one of the potential migration dispositions and the plurality of rationalization parameters.

A further embodiment of any of the foregoing methods, wherein determining the migration recommendation can include comparing, by the computing device, each disposition sum to every other disposition sum.

A further embodiment of any of the foregoing methods, wherein determining the migration recommendation can include selecting, by the computing device, the migration disposition corresponding to a maximum disposition sum among the plurality of disposition sums.

A further embodiment of any of the foregoing methods, wherein determining the plurality of disposition sums can include omitting, by the computing device, disposition weights associated with one of the plurality of rationalization parameters.

A further embodiment of any of the foregoing methods, wherein at least one of the rationalization parameters can be omitted when the disposition sums for the at least one rationalization parameters is equal for each migration disposition.

Computing Device for Automatically Preparing Application Data for Migration

A computing device according to an example embodiment of this disclosure includes, among other possible things, one or more processors and computer-readable memory. The computer-readable memory is encoded within instructions that, when executed by the one or more processors, cause the device to collect survey responses from a plurality of closed-form questions and assign a score to each of the survey responses to define a plurality of scores. Each of the questions is configured to elicit a survey response from one of a plurality of categories. The instructions can further cause the device to determine a normalized score associated with each of the plurality of scores to define a plurality of normalized scores. Each of the plurality of normalized scores range from a minimum normalized score to a maximum normalized score. The instructions can further cause the device to determine a plurality of rationalization parameters. Each of the rationalization parameters is based on a different subset of normalized scores associated with one of the plurality of categories. The instructions can further cause the device to determine a migration recommendation based on the rationalization parameters and automatically prepare an application package associated with the application based on the migration recommendation.

The computing device of the preceding paragraph can optionally include, additionally and/or alternatively, any one or more of the following features, configurations, additional components, and/or steps.

A further embodiment of the foregoing computing device, wherein preparing the application package can include aggregating, by the computing device, a plurality of data files into the application package.

A further embodiment of any of the foregoing devices, wherein preparing the application package can include generating, by the computing device, one or more migration scripts that are executed to perform at least a portion of a migration workload.

A further embodiment of any of the foregoing devices, wherein the plurality of categories can include an organization category relating to migration preferences of the organization, an application value category relating to a value of the application, a rationalization cost category relating to a cost of migrating the application, and a migration scoping category relating to feasibility of a plurality of potential migration recommendations.

A further embodiment of any of the foregoing devices, wherein each of the plurality of scores can be an integer between a minimum integer and a maximum integer inclusive.

A further embodiment of any of the foregoing devices, wherein determining the plurality of rationalization parameters can include determining, by the computer device, a current value of the application based on a first subset of normalized scores associated with the application value category.

A further embodiment of any of the foregoing devices, wherein determining the plurality of rationalization parameters can include a time to market score of the application based on a second subset of normalized scores associated with the application value category.

A further embodiment of any of the foregoing devices, wherein determining the plurality of rationalization parameters can include determining, by the computing device, an ability to innovate score based on a third subset of normalized scores associated with the application value category.

A further embodiment of any of the foregoing devices, wherein determining the current value of the application can include determining, by the computing device, a first mean of the first subset of normalized scores.

A further embodiment of any of the foregoing devices, wherein determining the time-to-market score can include determining, by the computing device, a second mean of the second subset of normalized scores.

A further embodiment of any of the foregoing devices, wherein determining the ability to innovate score can include determining, by the computing device, a third mean of the third subset of normalized scores.

A further embodiment of any of the foregoing devices, wherein determining the plurality of rationalization parameters can include determining, by the computing device, an unrealized value of the application based on the current value, the time-to-market score, and the ability-to-innovate score.

A further embodiment of any of the foregoing devices, wherein the unrealized value can equal a produce of the current value and a summation of an inverse of the time-to-market score and an inverse of the ability-to-innovate score.

A further embodiment of any of the foregoing devices, wherein determining the plurality of rationalization parameters can include determining, by the computing device, an application risk score based on a fourth subset of normalized scores associated with the application value category.

A further embodiment of any of the foregoing devices, wherein determining the application risk score can include determining, by the computing device, a sum of the fourth subset of normalized scores.

A further embodiment of any of the foregoing devices, wherein determining the plurality of rationalization parameters can include determining, by the computing device, a risk-adjusted current value equal to the current value divided by the application risk score.

A further embodiment of any of the foregoing devices, wherein determining the plurality of rationalization parameters can include determining, by the computing device, a risk adjust unrealized value equal to the unrealized value divided by the application risk score.

A further embodiment of any of the foregoing devices, wherein determining the plurality of rationalization parameters can include determining, by the computing device, a current value tier and an unrealized value tier.

A further embodiment of any of the foregoing devices, wherein the current value tier can be greater than or equal to a minimum tier threshold and less than a maximum tier threshold.

A further embodiment of any of the foregoing devices, wherein the minimum tier threshold and the minimum tier threshold can be determined based on a fifth subset of normalized score corresponding to the organization category.

A further embodiment of any of the foregoing devices, wherein determining the migration recommendation can include assigning a plurality of disposition weights.

A further embodiment of any of the foregoing devices, wherein each disposition weight can correspond to one of the plurality of potential migration dispositions and one of the plurality of rationalization parameters.

A further embodiment of any of the foregoing devices, wherein determining the migration recommendation can include determining, by the computing device, a plurality of disposition sums.

A further embodiment of any of the foregoing devices, wherein each disposition sum can be equal to a sum of disposition weights associated with one of the potential migration dispositions and the plurality of rationalization parameters.

A further embodiment of any of the foregoing devices, wherein determining the migration recommendation can include comparing, by the computing device, each disposition sum to every other disposition sum.

A further embodiment of any of the foregoing devices, wherein determining the migration recommendation can include selecting, by the computing device, the migration disposition corresponding to a maximum disposition sum among the plurality of disposition sums.

A further embodiment of any of the foregoing devices, wherein determining the plurality of disposition sums can include omitting, by the computing device, disposition weights associated with one of the plurality of rationalization parameters.

A further embodiment of any of the foregoing devices, wherein at least one of the rationalization parameters can be omitted when the disposition sums for the at least one rationalization parameters is equal for each migration disposition.

While the invention has been described with reference to an example embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of migrating an application utilized by an organization, the method comprising:
collecting, by a computing system, survey responses to a plurality of closed-form questions, each of the questions configured to elicit a survey response from one of a plurality of categories;
assigning, by the computing device, a score to each of the survey responses to define a plurality of scores;
determining, by the computing device, a normalized score associated with each of the plurality scores to define a plurality of normalized scores, each of the plurality of normalized scores ranging from a minimum normalized score to a maximum normalized score;
determining, by the computing device, a plurality of rationalization parameters, each rationalization parameter based on a different subset of normalized scores associated with one of the plurality of categories;
determining, by the computing device, a migration recommendation based on the rationalization parameters; and
automatically preparing, by the computing device, an application package associated with the application based on the migration recommendation, wherein preparing the application package comprises:
aggregating, by the computing device, a plurality of data files into the application package;
generating, by the computing device, one or more migration scripts that are executed to perform at least a portion of a migration workload.

2. The method of claim 1, wherein the plurality of categories includes an organization category relating to migration preferences of the organization, an application value category relating to a value of the application, a rationalization cost category relating to a cost of migrating the application, and a migration scoping category relating to feasibility of a plurality of potential migration recommendations.

3. The method of claim 1, wherein each of the plurality of scores is an integer between a minimum integer and a maximum integer inclusive.

4. The method of claim 2, wherein determining the plurality of rationalization parameters includes determining, by the computing device, a current value of the application based on a first subset of normalized scores associated with the application value category.

5. The method of claim 4, wherein determining the plurality of rationalization parameters includes determining, by the computing device, a time to market score of the application based on a second subset of normalized scores associated with the application value category.

6. The method of claim 5, wherein determining the plurality of rationalization parameters includes determining, by the computing device, an ability to innovate score based on a third subset of normalized scores associated with the application value category.

7. The method of claim 6, wherein determining the current value of the application includes determining, by the computing device, a first mean of the first subset of normalized scores, and wherein determining the time to market score includes determining, by the computing device, a second mean of the second subset of normalized scores, and wherein determining the ability to innovate score includes determining, by the computing device, a third mean of the third subset of normalized scores.

8. The method of claim 7, wherein determining the plurality of rationalization parameters includes determining, by the computing device, an unrealized value of the application based on the current value, the time to market score, and the ability to innovate score.

9. The method of claim 8, wherein the unrealized value equals a product of the current value and a summation of an inverse of the time to market score and an inverse of the ability to innovate score.

10. The method of claim 9, wherein determining the plurality of rationalization parameters includes determining, by the computing device, an application risk score based on a fourth subset of normalized scores associated with the application value category.

11. The method of claim 10, wherein determining the application risk score includes determining, by the computing device, a sum of the fourth subset of normalized scores.

12. The method of claim 11, wherein determining the plurality of rationalization parameters includes determining, by the computing device, a risk-adjusted current value equal to the current valve divided by the application risk score.

13. The method of claim 12, wherein determining the plurality of rationalization parameters includes determining, by the computing device, a risk-adjusted unrealized value equal to the unrealized value divided by the application risk score.

14. The method of claim 13, wherein determining the plurality of rationalization parameters includes determining, by the computing device, a current value tier and an unrealized value tier, and wherein the current value tier is greater than or equal to a minimum tier threshold and less than a maximum tier threshold, and wherein the minimum tier threshold and the maximum tier threshold are determined based on a fifth subset of normalized scores corresponding to the organization category.

15. The method of claim 1, wherein determining the migration recommendation includes:
assigning, by the computing device, a plurality of disposition weights, each disposition weight corresponding to one of the plurality of potential migration dispositions and one of the plurality of rationalization parameters.

16. The method of claim 14, wherein determining the migration recommendation includes:
determining, by the computing device, a plurality of disposition sums, each disposition sum equal to a sum of disposition weights associated with one of the potential migration dispositions and the plurality of rationalization parameters; and
comparing each disposition sum to every other disposition sum.

17. The method of claim 15, wherein determining the migration recommendation includes:
selecting, by the computing device, the migration disposition corresponding to a maximum disposition sum among the plurality of disposition sums.

18. The method of claim 1, wherein determining the plurality of disposition sums includes:
omitting disposition weights associated with one of the plurality of rationalization parameters.

19. A computing device comprising:
one or more processors; and
computer-readable memory encoded with instructions that, when executed by the one or more processors, cause the computing device to:
collect survey responses to a plurality of closed-form questions, each of the questions configured to elicit a survey response from one of a plurality of categories;
assign a score to each of the survey responses to define a plurality of scores;
determine a normalized score associated with each of the plurality scores to define a plurality of normalized scores, each of the plurality of normalized scores ranging from a minimum normalized score to a maximum normalized score;
determining, by the computing device, a plurality of rationalization parameters, each rationalization parameter based on a different subset of normalized scores associated with one of the plurality of categories;
determining, by the computing device, a migration recommendation based on the rationalization parameters; and
automatically preparing, by the computing device, an application package associated with the application based on the migration recommendation, wherein preparing the application package comprises:
aggregating, by the computing device, a plurality of data files into the application package;
generating, by the computing device, one or more migration scripts that are executed to perform at least a portion of a migration workload.

20. The computing device of claim 19, wherein the plurality of categories includes an organization category relating to migration preferences of the organization, an application value category relating to a value of the application, a rationalization cost category relating to a cost of migrating the application, and a migration scoping category relating to feasibility of a plurality of potential migration recommendations.
